(19) United States
(12) Patent Application Publication
(10) Pub. No.: US 2003/0013402 A1
(43) Pub. Date: Jan. 16, 2003

(54) Apparatus for raising the wrappers in a coinsorting machine

(76) Inventor: Takwan Lim, Inchon (KR)

Correspondence Address: Roberts Abokhair & Mardula, LLC, Suite 1000, 11800 Sunrise Drive, Reston, VA, 20191-5302, US

(21) Appl. No.: 09/906,160

(22) Filed: Jul. 16, 2001

(51) Int. Cl. G07D 9/00; G07D 9/04

(52) U.S. Cl. 453/59

(57) ABSTRACT

An apparatus for raising a wrapper in a coin-sorting machine is disclosed. The lower end of the wrapper is disposed upon an annular pushing device, and when coins are stacked within the wrapper to the full height, a pair of buttons are pulled up so that the annular pushing device can push up the wrapper together with the stacked coins with a uniformly applied force, thereby making the upper portion of the wrapper projected above the tube. Thus the upper end of the wrapper can be easily sealed.

### FIELD OF THE INVENTION

The present invention relates to an apparatus for raising the wrappers in a coin-sorting machine. Particularly, the present invention relates to an apparatus for raising the wrappers in a coin-sorting machine, in which an annular pushing device is installed within a lower portion of a tube in a close-fitted state, a pair of buttons are installed on the outside of the tube, and the buttons move up and down along guides, thereby raising the wrapper with a uniform force.

### BACKGROUND OF THE INVENTION

A tube 11 for accommodating the coins of a coin-sorting machine has a size suiting to the size of the relevant coins 21, and within the tube 11, there is disposed a wrapper 12 having a diameter same as the inside diameter of the tube, so that the coins can be stacked into the wrapper 12. When the coins 21 are filled into the wrapper 12, the wrapper 12 is separated from the tube 11, and the mouth of the wrapper 12 is sealed.

As shown in FIG. 6, the tube 11 is constituted such that its bottom portion is bent inward, and then the bent portion is bent upward, thereby forming a projected part 16 integrally with the tube 11.

Both ends of the wrapper 12 are open, and one of the ends is bent inward to form a step 27.

If the wrapper 12 is inserted into the tube 11, the projected part 16 is accommodated within the wrapper 12, with the lower end of the wrapper 12 being made even with the lower end of the projected part 16, while the upper end of the wrapper 12 is made even with the upper end of the tube 11.

In the above-described structure, the dropping coins 21 are stacked upon the projected part 16. If the coins 21 are stacked up to the top of the tube 11, then the tube 11 is separated from a box 13. Then if the wrapper 12 is pushed up with hand by inserting the hand into an open part 24, then the wrapper 12 is projected from the tube 11, and then, the operating person can seal the upper end of the wrapper 12. This is the constitution of the conventional apparatus.

In the above-described conventional apparatus, the wrapper 12 is pushed up in the above-described manner. That is, the force is imposed on the one end of the wrapper, and therefore, if an oppositely directed force acts, that is, when the coins are stacked on the projected part 16, the stacked coins are biased to one side within the wrapper 12.

Therefore, the biased portion of the wrapper 12 is closely contacted to the tube to impede the ascending of the wrapper. As a result, the closely contacted portion of the wrapper undergoes a deformation, and therefore, a perfect wrapping cannot be expected. Further, inside the open part 24, there are a number of sharp portions, and therefore, the hand may be hurt.

### BRIEF SUMMARY OF THE INVENTION

The present invention is intended to overcome the above-described disadvantages of the prior art.

Therefore it is an object of the present invention to provide an apparatus for raising the wrapper in a coin-sorting machine, in which the stacked coins are prevented from being biased, and the pushing-up forces are imposed on the entire edge surface of the lower end of the wrapper, so that the wrapping of the coins would become perfect, and an operating safety can be ensured.

In achieving the above object, the apparatus for raising a wrapper in a coin-sorting machine according to the present invention includes: a tube 11, with its both ends being open, with its one end having two symmetric guides 17, and with its inside having inside threads 23a; a plug 22 having outside threads 23b for being threadably coupled to the inside threads 23a of the tube 11, with a projected part 16 upstanding at a center of the plug 22; and an annular pushing device 14 (having a shape of a ring 26) for being coupled to the projected part 16, and for settling a wrapper on a top of it, whereby the ring 26 of the annular pushing device 14 can be moved up and down by only manipulating a pair of buttons 15 and the plug 22 prevents the annular pushing device 14 from departing out of the guides 17 of the tube 11.

### BRIEF DESCRIPTION OF THE DRAWINGS

The above object and other advantages of the present invention will become more apparent by describing in detail the preferred embodiment of the present invention with reference to the attached drawings in which:

FIG. 1A illustrates a state before the actuation of the pushing device;

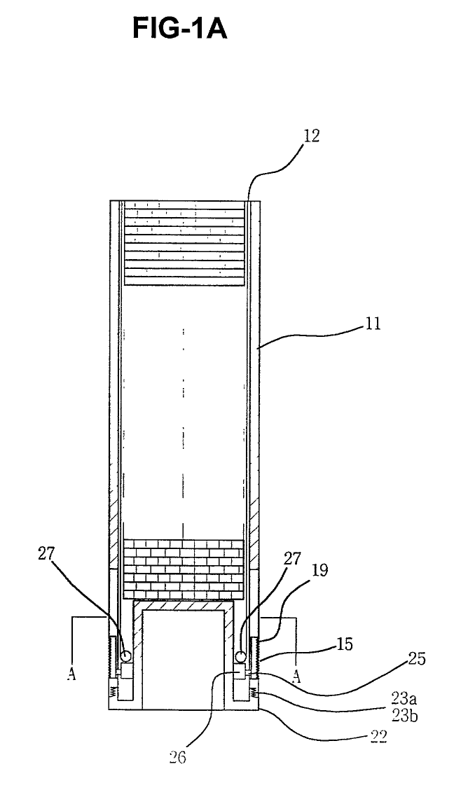

FIG. 1B illustrates a state after the actuation of the pushing device;

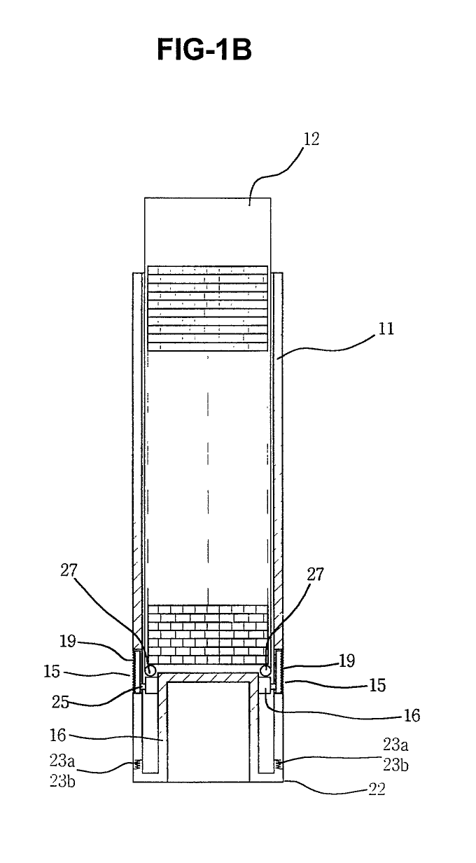

FIG. 2 is a partly cut-out view of the tube;

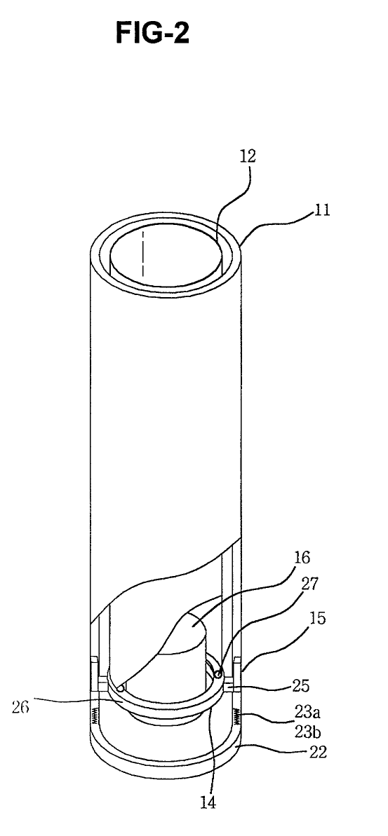

FIG. 3 illustrates the shape of the pushing device;

FIG. 4 is a sectional view taken along a line A-A′;

FIG. 5 illustrates the working of the apparatus according to the present invention;

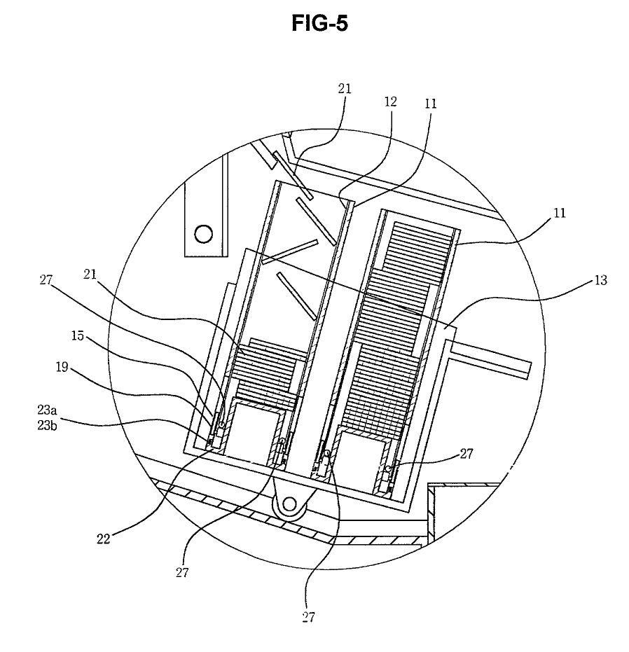

FIG. 6 illustrates the constitution of the conventional tube; and

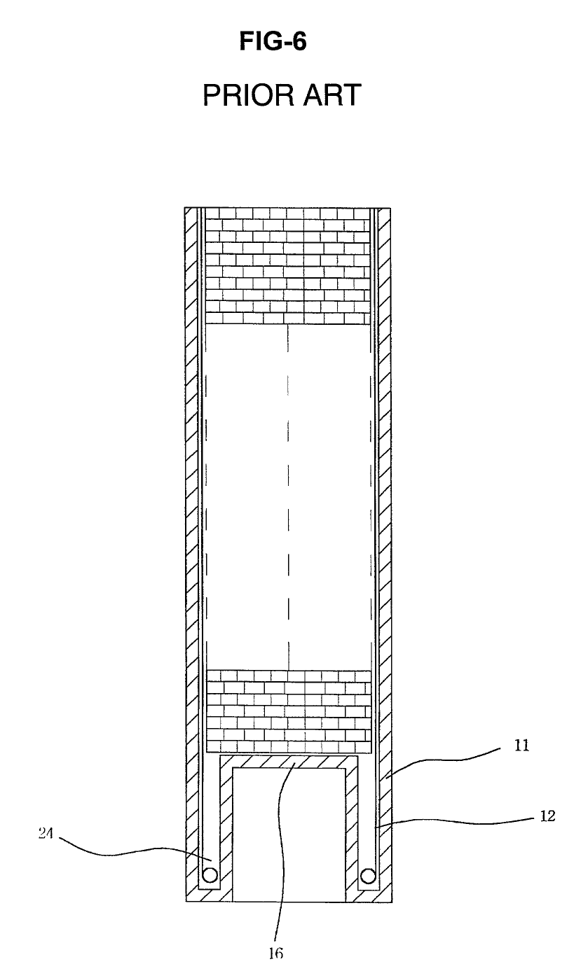

FIG. 7 is an exploded perspective view of the apparatus according to the present invention.

### DETAILED DESCRIPTION OF THE INVENTION

In the present invention, there is described an apparatus for packing the coins in a perfect manner by raising the wrapper within the tube 11 with a uniform force.

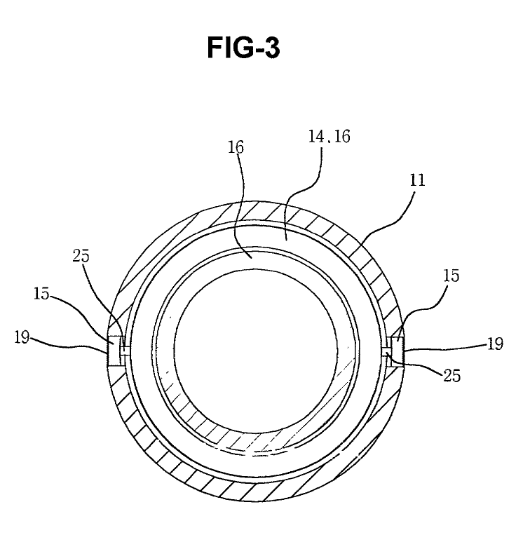

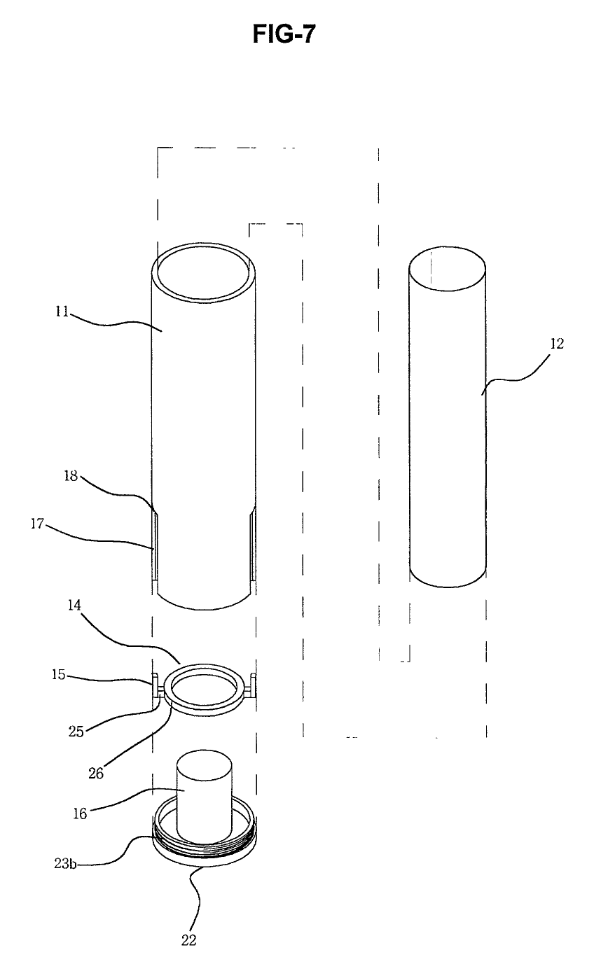

As shown in FIG. 7, the tube 11 in which the both ends are open is provided with two symmetric guides 17 in a form of slit. Further, as shown in FIGS. 3 and 7, an elongate step 18 is formed around each of the guides 17, and a plurality of inside threads 23a are formed on the inside of the tube 11.

Further, as shown in FIG. 7, there is provided a plug 22 with outside threads 23b on its circumference and with a projected part 16 at its center, so that the plug 22 can threadably coupled with the tube 11.

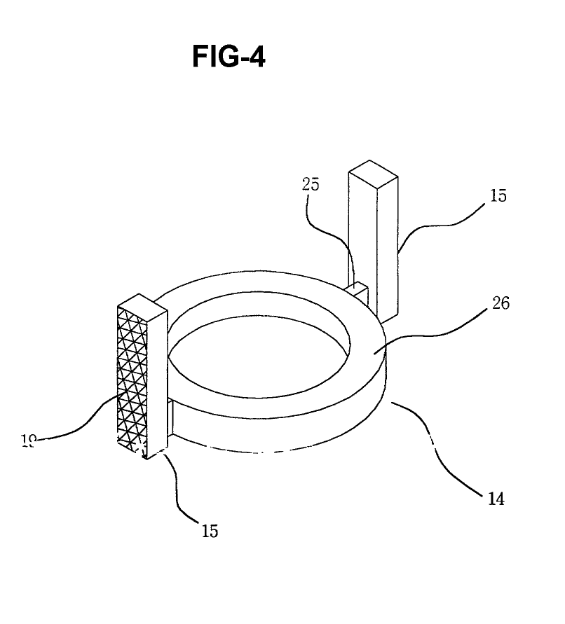

A ring 26 of an annular pushing device 14 is coupled to the projected part 16 of the plug 22, and two supporting pieces 25 are formed on the ring 26. The supporting pieces 25 are respectively connected to a pair of buttons 15, and a pair of protuberances 19 stand at both sides of the ring 26 by being connected to the supporting pieces as shown in FIG. 4.

Generally, within a box 13 of a coin-sorting machine, there stand a plurality of tubes 11, so that differently sized coins can be stacked into the relevant tubes 11. Inside each of the tubes 11, there is inserted a wrapper 12, and therefore, actually the coins are stacked within the wrapper 12.

If the coins 21 are completely filled in the wrapper 12, then the relevant tube 11 is detached from the box 13, and then, the wrapper 12 is separated from the tube 11, so that the upper end of the wrapper can be sealed by a mechanism.

However, when the wrapper 12 is separated from the tube 11, a human hand is put into an open part 24 that is formed in the lower portion of the tube 11, so as to push up the wrapper 12. Thus the upper end of the wrapper 12 with the coins filled is sealed at the next stage.

In this conventional structure, the size of the open part 24 is limited, and therefore, if the finger is thick, then not only the wrapper 12 cannot be pushed up, but also the finger may be hurt by sharp portions. Further, a part of the wrapper 12 can be deformed (shrunk), and therefore, the present invention is intended to overcome the above-described disadvantages of the conventional technique.

If the pushing device 14 is fitted into the tube 11, then the supporting pieces 25 that are formed on the ring 26 of the pushing device 14 are fitted into the guides 17 to be supported in them. Thus the pushing device 14 closely contacts to the inside of the tube 11, while the buttons 15 are settled respectively within the elongate steps 18 which are respectively formed around the guides 17 and on the outside circumference of the tube 11.

After fitting the pushing device 14 into the guides 17, the plug 22 is coupled into the tube 11. When the plug 22 is coupled into the tube 11, the threads 23b of the plug 22 and the threads 23a of the tube 11 are utilized to threadably couple them together. If the plug 22 is fitted into the tube 11, the ring 26 of the pushing device 14 is settled evenly with the bottom of the projected part 16 of the plug 22.

Under this condition, if the wrapper 12 is inserted into the tube 11 through its upper mouth, then the lower end of the wrapper 12 is settled onto the ring 26 after covering the projected part 16. That is, the projected part 16 stands within the wrapper 12 to a certain height, while the upper end of the wrapper 12 is made even with the upper end of the tube 11.

In the above-described situation, if the coins are dropped, then the coins are stacked upon the projected part 16, and if the coins are stacked to the full height, then the tube 11 is detached from within the box 13.

After detaching the tube 11 from the box 13, if the two buttons 15 are held with two fingers and are pulled up, then the ring 26 is pulled up within the tube 11. Accordingly, the wrapper 12 which is settled upon the ring 26 is also pushed up within the tube 11 together with the ring 26. As a result, the upper portion of the wrapper 12 is exposed as much as pushed up, and therefore, the sealing becomes easy.

According to the present invention as described above, the entire lower portion of the wrapper is subjected to a uniform lifting force only by manipulating the two buttons with two fingers, thereby lifting the wrapper together with the stacked coins with a uniform force. Accordingly, any deformation of the wrapper can be prevented, Further, there is no open part unlike the conventional tube, and therefore, there is no problem such that the open part is too small to insert a finger, or that the finger is hurt by sharp portions with the open part.

What is claimed is:

1. An apparatus for raising a wrapper in a coin-sorting machine, comprising:
a tube having first and second open ends, wherein the first open end includes two symmetric guides and inside threads on an inner portion thereof;
a plug having outside threads for being threadably coupled to the inside threads of the tube and further including a projected part upstanding at a center of the plug; and
an annular pushing device including
a ring for being coupled to the projected part and for settling a wrapper on a top of, and
a pair of buttons engaging said symmetric guides;
whereby the ring of the annular pushing device can be moved up and down by only manipulating the pair of buttons and the plug prevents the buttons of the annular pushing device from departing out of the symmetric guides of the tube.

2. The apparatus as claimed in [c1], wherein the pair of the buttons are dimensioned in elongate steps in such a manner so as not to project beyond an outside surface of the tube.

3. The apparatus as claimed in [c1], wherein each of the buttons is provided with a plurality of non-slip projections so as to prevent slippage when manipulating the buttons.
